(19) United States
(12) Patent Application Publication
(10) Pub. No.: US 2010/0028603 A1
(43) Pub. Date: Feb. 4, 2010

(54) Articles having camouflage pattern and method of making same

(76) Inventor: Christopher L. Sharp, Haysville, NC (US)

Correspondence Address: CHRISTOPHER L. SHARP, 756 South Carter Cove Road, Haysville, NC, 28904, US

(21) Appl. No.: 12/287,328

(22) Filed: Oct. 8, 2008

Related U.S. Application Data
(60) Provisional application No. 60/997,860, filed on Oct. 9, 2007.

(51) Int. Cl. B32B 3/00; B44C 1/00

(52) U.S. Cl. 428/151; 156/59

(57) ABSTRACT

A camouflage pattern characterized by a textured background simulating the bark of a tree and a random pattern of tree limbs, branches, twigs and leaves superimposed upon the textured bark-like background. The limbs, branches and twigs are of dissimilar size or caliber, and extend in all different directions. The leaf elements are of differing size and color and have differing orientations. The overall look or visual impression conveyed by the unique camouflage pattern of the present invention has been found to simulate the natural look of a forest, or more particularly, the look of tree branches, limbs, twigs and leaves that have fallen onto a forest floor. The camouflage pattern of the present invention may be used on a wide variety of articles including clothing articles such as, for example, a baseball-style hat or cap.

### CROSS-REFERENCE TO RELATED APPLICATION

This application claims priority based upon my copending Provisional Application Ser. No. 60/997,860; filed Oct. 9, 2007.

### BACKGROUND OF THE INVENTION

1. Field of the Invention

The present invention relates generally to camouflage articles, and, more particularly, to camouflage articles that are derived from images comprising a combination of natural objects.

2. Description of the Prior Art

The use of camouflage is well known in the arts of hunting and in the military arts. For example, camouflage cloth is used in the fabrication of clothing. Also, camouflage patterns are painted on the exterior surfaces of vehicles and buildings and used on the surface of articles such as firearms and binoculars and optical scopes. Camouflage patterns often are derived from images of naturally occurring objects such as animals, insects, birds, tree branches or bark, leaves and other foliage, or combinations of such objects. For example, in U.S. Pat. No. 5,773,101 (Sanders), there is disclosed a camouflage pattern comprising three-dimensional folds extending from the plane of an underlying sheet or surface. This patent suggests (Col. 7, lines 19-20) natural images such as woods, tree bark, branches, brush plants, and grass may be photographic images transferred to the sheet. The disclosure of the foregoing U.S. Pat. No. 5,773,101 (Sanders) hereby is incorporated herein and made part of this specification by this reference.

Camouflage patterns have become so widespread and popular they are even used throughout the world of fashion to ornament clothing, shoes, bags, hats and so on. It would be desirable if a camouflage pattern were to be invented that would comprise images of natural objects combined in such a way as to render the resulting camouflage pattern more effective for its intended use either as a camouflage element per se, or as a fashion statement, or both.

### BRIEF SUMMARY OF THE INVENTION

To achieve the foregoing and other advantages, the present invention, briefly described, comprises a camouflage pattern characterized by a textured background simulating the bark of a tree and a random pattern of tree limbs, branches, twigs and leaves superimposed upon the textured bark-like background. The limbs, branches and twigs are of dissimilar size or caliber, and extend in all different directions. The leaf elements are of differing size and color and have differing orientations. The overall look or visual impression conveyed by the unique camouflage pattern of the present invention has been found to simulate the natural look of a forest, or more particularly, the look of tree branches, limbs, twigs and leaves that have fallen onto a forest floor. The camouflage pattern of the present invention may be used on a wide variety of articles including clothing articles such as, for example, a baseball cap.

The above brief description sets forth rather broadly the more important features of the present invention in order that the detailed description thereof that follows may be better understood, and in order that the present contributions to the art may be better appreciated. There are, of course, additional features of the invention that will be described hereinafter and which will be for the subject matter of the claims appended hereto.

In this respect, before explaining a number of preferred embodiments of the invention in detail, it is understood that the invention is not limited in its application to the details of the construction and to the arrangements of the components set forth in the following description or illustrated in the drawings. The invention is capable of other embodiments and of being practiced and carried out in various ways. Also, it is to be understood, that the phraseology and terminology employed herein are for the purpose of description and should not be regarded as limiting.

As such, those skilled in the art will appreciate that the conception, upon which disclosure is based, may readily be utilized as a basis for designing other structures, methods, and systems for carrying out the several purposes of the present invention. It is important, therefore, that the claims be regarded as including such equivalent constructions insofar as they do not depart from the spirit and scope of the present invention.

It is therefore an object of the present invention to provide a new and improved camouflage article and method which has all of the advantages of the prior art and none of the disadvantages.

It is another object of the present invention to provide a new and improved camouflage article and method which may be easily and efficiently manufactured and marketed.

It is a further object of the present invention to provide a new and improved camouflage article and method which is of durable and reliable construction.

An even further object of the present invention is to provide a new and improved camouflage article and method which is susceptible of a low cost of manufacture with regard to both materials and labor, and which accordingly is then susceptible of low prices of sale to the consuming public, thereby making such camouflage article and method available to the buying public.

Still yet a further object of the present invention is to provide a new and improved camouflage article and method providing camouflage patterns derived from images comprising combined naturally occurring elements and wherein the camouflage pattern may be applied to a wide variety of different articles.

Yet still another object of the present invention is to provide a new and improved camouflage article and method providing a camouflage pattern that may be applied to a wide variety of articles and wherein the camouflage pattern is derive from an image comprising a combination of naturally occurring objects including, but not limited to bark, tree trunks, branches, twigs, leaves all of differing texture and color.

Still another object of the present invention is to provide a new and improved camouflage article and method providing a camouflage pattern that may be applied to a wide variety of articles such as a baseball cap, for example.

Yet still another object of the present invention is to provide an improved camouflage article and method providing a camouflage pattern comprising an image derived from a combination of naturally occurring objects wherein the pattern is applied to an article by printing the camouflage pattern on a flexible member, cutting the flexible member into different pieces, and affixing the different pieces together in a random manner.

These together with still other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

These together with still other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and the above objects as well as objects other than those set forth above will become more apparent after a study of the following detailed description thereof. Such description makes reference to the annexed drawing wherein:

FIG. 1 is a facsimile of a camouflage pattern produced in accordance with the invention and wherein the pattern comprises an image of combined naturally occurring elements such as tree branches, limbs, twigs and leaves against a bark-like textured background.

FIG. 2 is a diagram schematically depicting how a camouflage pattern may be produced in accordance with the invention by combining repeating images of the camouflage pattern of FIG. 1 to form a more extensive camouflage pattern.

FIG. 3 is a diagram schematically depicting a pattern of various shapes that may be cut from a flexible member to produce individual pieces each bearing the camouflage pattern of the present invention, or a portion thereof.

FIG. 4 is a exploded assembly depicting how various pieces bearing the camouflage pattern may be arranged to form a useful article such as a baseball cap.

FIG. 5 is a side view in elevation of a baseball cap made up of various pieces of material each bearing the camouflage pattern of the present invention.

FIG. 6 is top view of the hat depicted in FIG. 5.

### DESCRIPTION OF THE PREFERRED EMBODIMENT

With reference to the drawings, a new and improved article bearing a novel camouflage pattern and the method of making such camouflage articles embodying the principles and concepts of the present invention will be described.

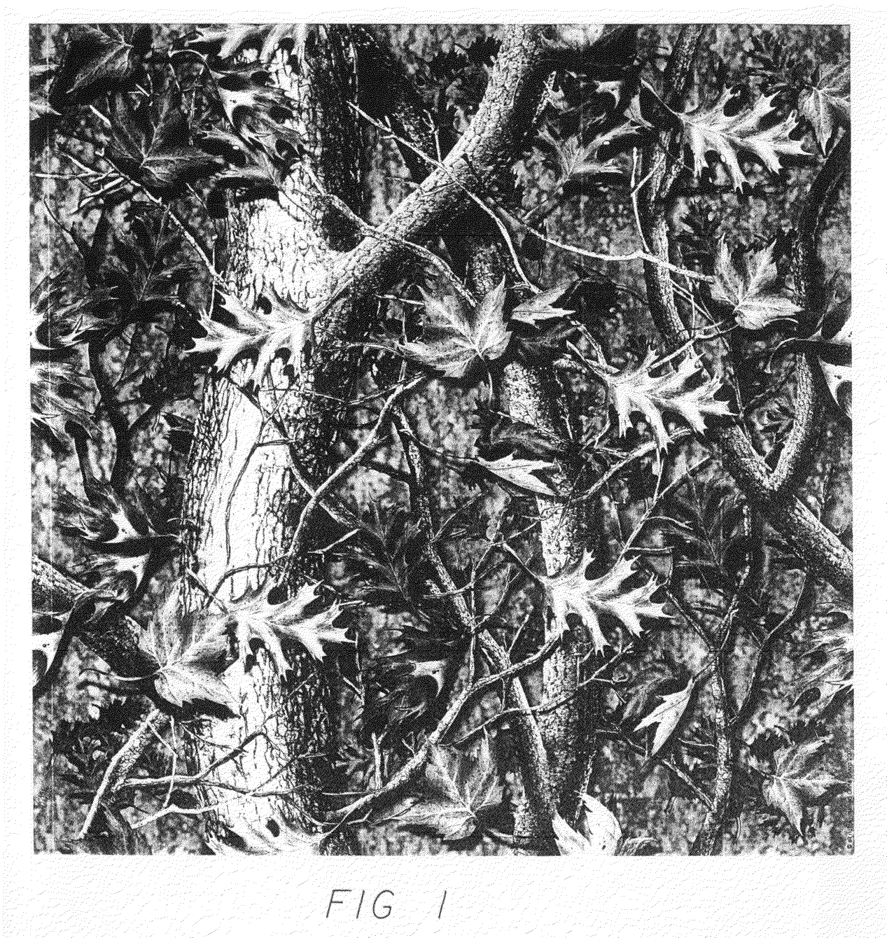

Turning now to FIG. 1, there is shown a facsimile of a portion of a camouflage pattern produced in accordance with the invention and wherein the pattern is characterized by a textured background simulating the bark of a tree and a random pattern of tree limbs, branches, twigs and leaves superimposed upon the textured bark-like background. The limbs, branches and twigs are of dissimilar size or caliber, and extend in many different directions. The leaf elements are of differing size and color and have many differing orientations. In accordance of the invention, the camouflage pattern of FIG. 1 although comprising integrated images of naturally occurring objects, actually presents a pattern that does not actually occur in nature and therefore may be considered to be non-naturally occurring image. The resulting non-naturally occurring camouflage “pattern” of the present invention, arrived at by integrating images of naturally occurring objects, has an overall look or conveys a visual impression simulating the natural look of a forest, or more particularly, simulates the look of tree branches, limbs, twigs and leaves that have fallen onto a forest floor. In particular, it is believed that use of the camouflage pattern of the invention will be particularly effective for helping the wearer or user “blend in” during the spring and fall. In this regard, it is to be understood that a different mix of colors for the “fallen leaf elements” may be employed, as desired, to give a look more nearly compatible with a particular seasonal use (e.g. spring or autumn).

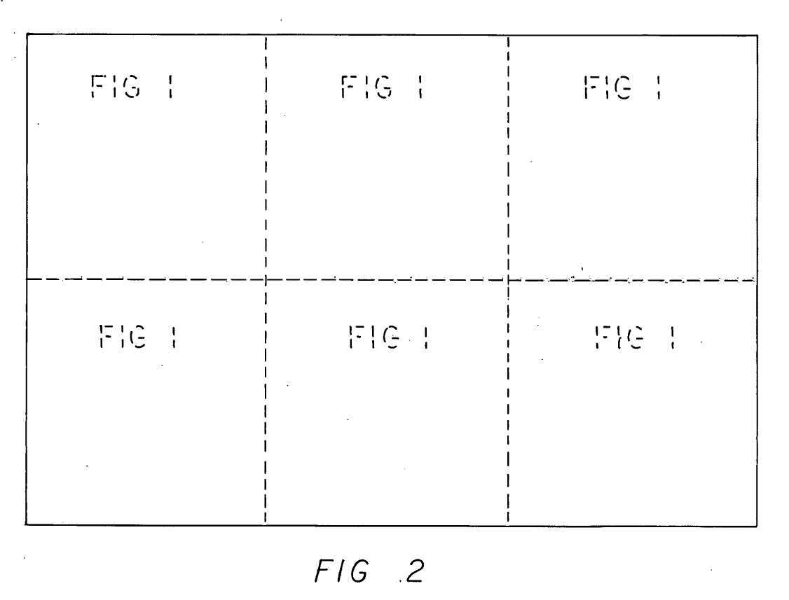

FIG. 2 shows how another camouflage pattern may be made in accordance with the present invention by repeating rows and columns of elements or images each one of which corresponds to the pattern of FIG. 1. The repetition pattern used to create the enlarged pattern of FIG. 2 may be applied to various articles, and in particular, is quite advantageous when applied to a flexible web or member, such as fabric material or the like, where the web is of indeterminate length. This will enable bolts of fabric material to be made bearing the camouflage pattern of the present invention which may then be conveniently stored on rolls or spools for easy handling, storage, processing and so on.

To make articles bearing the unique camouflage pattern(s) of the instant invention, the pattern or image of FIG. 1 may be derived using conventional computer software (e.g. Photoshop™). The camouflage pattern of FIG. 2 may the be formed by combining or repeating images of FIG. 1 in accordance with the diagram of FIG. 2. Finally, the resulting camouflage pattern of FIG. 2 can then be applied to a flexible sheet-like member or fabric utilizing say a conventional screen printing process as is well known in the art. The sheet member or fabric then may be applied to a useful article such as clothing or to a tent, to cite just a few examples.

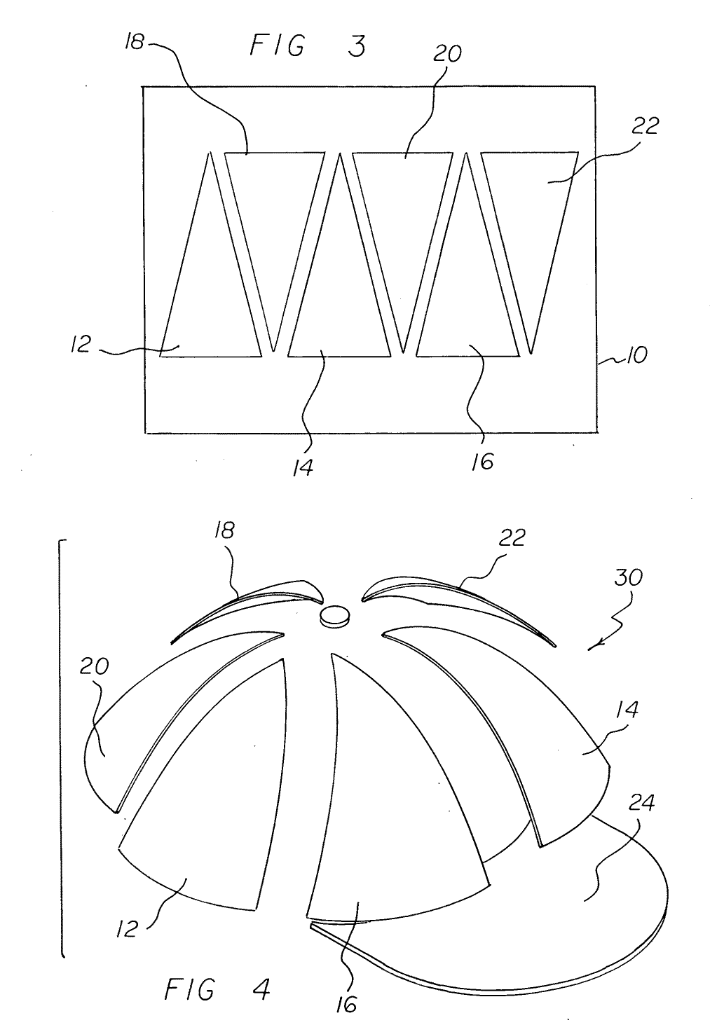

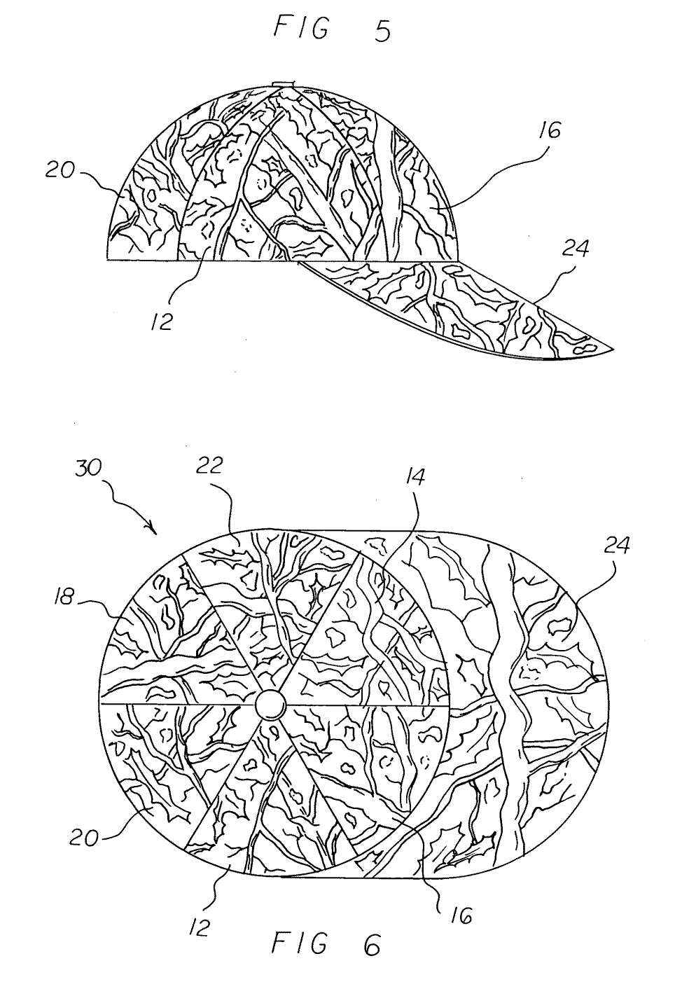

An example of the use of the camouflage pattern of the present invention will now be described in connection with FIGS. 3-6. The camouflage pattern derived in accordance with the invention can be applied to a baseball-style hat or cap 30 as depicted in FIGS. 5 and 6. The cap 30 has a brim 24 and pie-shaped crown sections 12, 14, 16, 18, 20 and 22 substantially as illustrated. The crown sections and brim are affixed together as by sewing in a manner well known in the art. In fabricating the hat 30, a flexible fabric member (FIG. 3) bearing the camouflage pattern of FIGS. 1 and 2 is cut into the various sections. The sections preferably then are randomly intermixed before being sewn together (FIG. 4). Then the brim is cut separately from the material of FIG. 3 (not shown), attached to a former or relatively stiff brim base member and sewn to and affixed to the crown. The resulting cap 30 (FIGS. 5 and 6) features random sections of the camouflage pattern according to the invention which random arrangement enhances the camouflage effect of the cap and presents a unique fashion statement in terms of its appearance.

The articles provided by the method of making camouflage articles of the invention can be made in sheet form from inexpensive and durable cloth, plastic or paper materials. Alternatively, the unique camouflage pattern of the present invention may be applied to a surface by painting, or engraving or other known surface treating or ornamenting methods.

The foregoing detailed description is considered as illustrative only of the principles of the invention. Numerous modifications and changes will readily occur to those skilled in the art and therefore, it is not desired to limit the invention to the exact construction and operation shown and described. For example, numerous other and different camouflage patterns may be produced using the method of the present invention by adding other pictorial image elements to the pattern. Accordingly, all suitable modifications and equivalents falling within the broad scope of the subject matter described above may be resorted to in carrying out the present invention.

Finally, it will be appreciated that the purpose of the annexed Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. Accordingly, the Abstract is neither intended to define the invention or the application, which only is measured by the claims, nor is it intended to be limiting as to the scope of the invention in any way.

What is claimed is:

1. An article comprising a camouflage pattern, wherein said camouflage pattern comprises at least one image of a naturally occurring object and at least one other image of a naturally occurring object, and wherein said at least one image and said at least one other image are integrated to form a non-naturally occurring object comprising said camouflage pattern.

2. The article of claim 1, further including an additional naturally occurring object as background to said at least one image and said at least one other image, said additional naturally occurring object being textured to simulate the bark of a tree.

3. The article of claim 2, wherein said at least one image is an image of the branches of a tree.

4. The article of claim 3 wherein said at least other image is an image of image of tree leaves.

5. The article of claim 4 wherein said camouflage pattern conveys a visual impression simulating leaves fallen on a forest floor.

6. The article of claim 5 wherein said camouflage pattern is applied to a flexible member.

7. The article of claim 6 wherein said flexible member is a fabric and said fabric is cut into a plurality of pieces, said plurality of pieces being pie-shaped such that they may be sewn together to form the crown of a cap.

8. The article of claim 7 wherein said pieces are randomly intermixed relative to each other before being sewn together to form said crown of said cap.

9. A method for making a camouflage pattern, said method comprising:
(a) obtaining one or more images of a first naturally occurring object,
(b) obtaining one or more images of a second naturally occurring object.
(c) creating a pattern with said images being combined to create an image of a non-naturally occurring object.

10. The method of claim 9, which further comprises placing said pattern on at least one article or covering all or a portion of at least one article with said pattern.

11. The method of claim 9, wherein said pattern is emplaced on at least one article.

12. The method of claim 9, wherein said first and second naturally occurring object are selected from the group comprising tree bark, tree branches, tree limbs, twigs or leaves.
